(19) United States
(12) Patent Application Publication
(10) Pub. No.: US 2016/0368204 A1
(43) Pub. Date: Dec. 22, 2016

(54) TOOL FOR INSTALLING A COMMUNICATION OR POWER LINE

(71) Applicant: COMMSCOPE TECHNOLOGIES LLC, HICKORY, NC (US)

(72) Inventors: Christopher E. Raynor, Holly Springs, NC (US); Barry Wayne Allen, Siler City, NC (US)

(21) Appl. No.: 15/161,578

(22) Filed: May 23, 2016

Related U.S. Application Data
(60) Provisional application No. 62/165,681, filed on May 22, 2015.

(51) Int. Cl. B29C 65/48; B29C 35/02

(52) U.S. Cl. CPC B29C 65/4815; B29C 35/02; B29L 2031/3462

(57) ABSTRACT

The present disclosure relates to a tool for attaching a line having pre-coated hot melt adhesive to a structure. The tool includes a heating device including a heating element, a working tip that mounts on a tip of the heating element, and a a line guide sleeve that mounts on the heating element axially adjacent to the working tip.

### CROSS REFERENCE TO RELATED APPLICATION

The present application claims priority to U.S. Provisional Patent Application Ser. No. 62/165,681, entitled “TOOL FOR INSTALLING A COMMUNICATION OR POWERLINE” and filed on May 22, 2015, the disclosure of which is hereby incorporated by reference in its entirety.

### BACKGROUND

Systems have been developed for routing and installing communication and power lines (e.g., optical cables, electrical cables, optical fibers, wires, etc.) within commercial and residential building structures. In some systems, hot-melt adhesive is used to secure the communication and/or power lines to building structures such as walls, ceilings, floors, moldings, frames and the like.

### SUMMARY

Certain aspects of the disclosure relate to a tool for installing a communication or power line that has been pre-coated with hot-melt adhesive. In certain examples, the tool includes a metal working tip that mounts on a heating element of a heat gun such as a soldering gun and that is configured to be rapidly heated to a desired working temperature suitable for softening the hot-melt adhesive. In certain examples the working tip includes a proximal end defining a receptacle for receiving a tip of the heating element and distal end that is rounded for pressing the adhesive coated line onto a building structure. In certain examples, the working tip defines an exterior groove that extends from the proximal end of the working tip along a length of the working tip and around the rounded distal end of the working tip. In certain examples, the working tip has a length less than 50 percent of the length of the heating element or less than 40 percent of the length of the heating element. In certain examples, the working tip has a weight less than 2.5 grams, or less than 2 grams, or less than 1.5 grams or less than 1.25 grams, or in the range of 1 to 2 grams or in the range of 1 to 1.5 grams. In certain examples, the working tip has a volume less than 0.07 cubic inches, or less than 0.06 cubic inches, or less than 0.05 cubic inches, or in the range of 0.02 to 0.06 cubic inches, or in the range of 0.03-0.05 cubic inches. In certain examples, the heat gun is battery powered and has a battery life of at least 2 hours of use. In certain examples battery/batteries provide an output voltage to the heating element of 3 volts. In certain examples, the batteries include two pairs of 1.5 volt batteries arranged in parallel. In certain examples, the heating element has a nominal temperature less than 400 F, or less than 300 F or less than 250 F. In certain examples, the tool also includes a guide sleeve that mounts on the heating element at a location axially adjacent to the proximal end of the working tip. In certain examples, the guide sleeve has a polymeric (e.g., plastic) construction. In certain examples, the guide sleeve has a non-heat conductive (i.e., dielectric) construction. In certain examples, the guide sleeve has a construction that is substantially less heat conductive than the construction of the working tip. In certain examples, the guide sleeve includes a main body defining a longitudinal passage that receives the heating element and that co-axially aligns with the receptacle of the working tip. In certain examples, the guide sleeve includes a longitudinal line guide channel that co-axially aligns with the exterior groove of the working tip. In certain examples, the guide sleeve is configured such that that a line can be laterally loaded into line guide channel. In certain examples, the guide sleeve includes line retention tabs that are axially separated from one another and that overhang the line guide channel. In certain examples, the line retention tabs have base ends connected to channel rails of the guide sleeve on opposite sides of the line guide channel. In certain examples the line retention tabs are separated by a slot that extends at an oblique angle relative to a longitudinal axis of the line guide channel.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 depicts a heating gun that can be used as part of a tool in accordance with the principles of the present disclosure;

FIG. 2 depicts a heating element of the heating gun of FIG. 1;

FIG. 3 depicts a working tip in accordance with the principles of the present disclosure that is configured to be mounted on a tip of the heating element of FIG. 1;

FIG. 4 depicts a line guide sleeve in accordance with the principles of the present disclosure configured to mount on the heating element adjacent to the working tip;

FIG. 5 depicts the working tip and the line guide sleeve assembled together with a line routed therethrough which is being pressed against a structure such as a wall to adhere the line to the wall; and

FIG. 6 depicts the working tip and the line guide sleeve assembled on the heating element.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

Certain aspects of the disclosure relate to a tool for installing a communication or power line that has been pre-coated with hot-melt adhesive. An example line coated with hot-melt adhesive suitable for use with the tool disclosed herein is disclosed in U.S. patent application Ser. No. 14/063,732 which is hereby incorporated by reference in its entirety.

In certain examples, aspects of the present disclosure relate to a line installation tool including a heating device such as a heat gun (e.g., a soldering gun), a working tip that mounts on a tip of heating element and a line guide sleeve that mounts on the heating element axially adjacent to the working tip. In certain examples, primary heating to the heating element occurs at the tip of the heating element while the remainder of the heating element does not undergo substantial heating. In one example, the working tip coincides with a portion of the heating element that undergoes substantial heating, and the line guide sleeve coincides with a portion of the heating element that does not undergo substantial heating. In one example, the working tip is made of a heat conductive material such as metal and the line guide sleeve is made of a non-heat conductive material such as plastic. The small size of the working tip means that the working tip has a relatively small thermal mass that can quickly be heated by the heating element to a temperature suitable for softening the hot-melt adhesive of the line (e.g., 150-250 degrees F.). This allows the heating element to be operated at relatively low nominal temperatures (e.g., less than 300 degrees F. or less than 250 degrees F.).

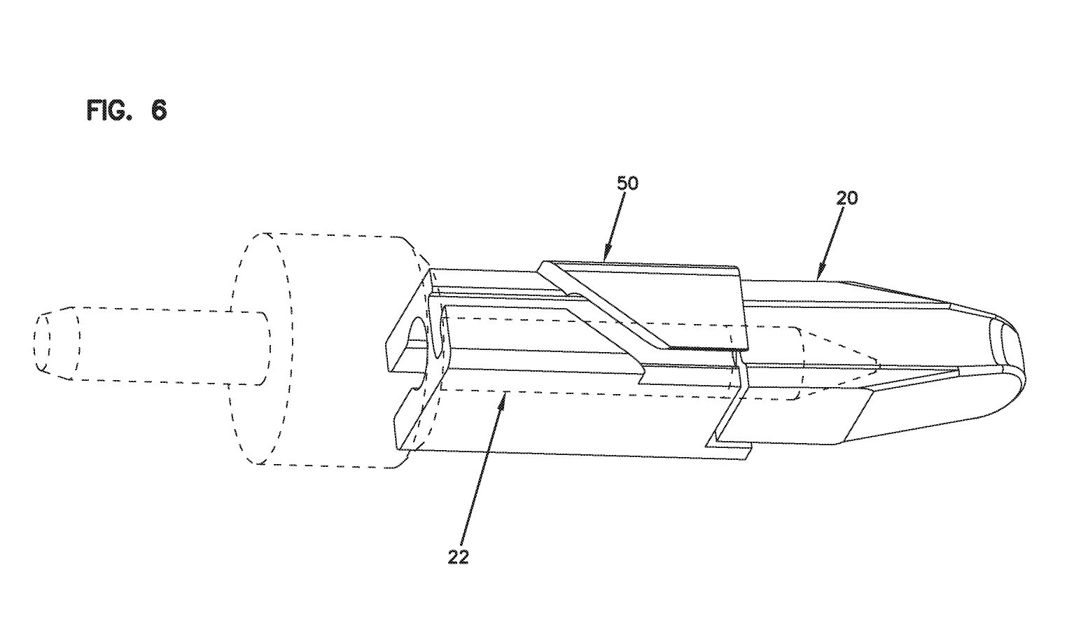

In use of the tool, the line guide sleeve and the working tip are installed on the heating element (see FIG. 6). The heat gun is then used to heat the heating element which in turn heats the working tip to a working temperature suitable for softening the hot-melt adhesive of the line. The line (e.g., an adhesive coated optical fiber) is fed from a source such as a spool through the line guide sleeve and across the working tip. Once the working tip reaches the working temperature, the installer can press the line against a structure to which it is desired to adhere the line (e.g., a wall, ceiling, floor, etc.). The installer moves the tip across the structure while concurrently pressing the line against the structure. As the tip is moved across the structure, the line is pulled from the spool, passes through the line guide sleeve, passes across the working tip, and is pressed onto the structure (see FIG. 5). As the line moves across the working tip, the line is heated to a temperature where the adhesive is softened to the point where the line will stick to the structure upon being pressed against the structure by the installer through the working tip.

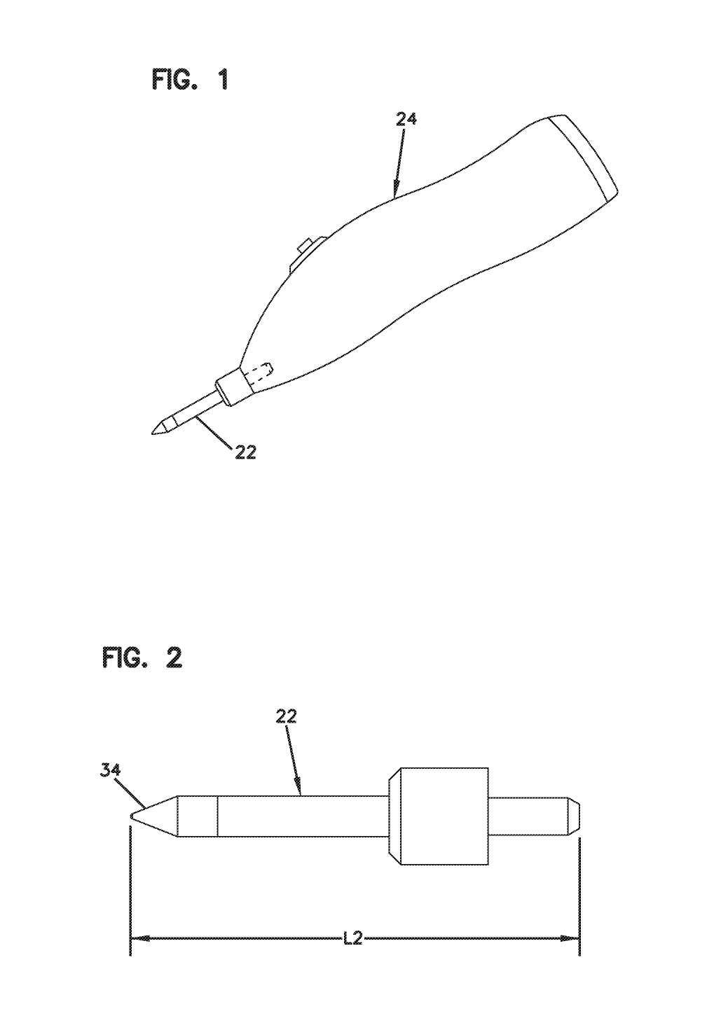

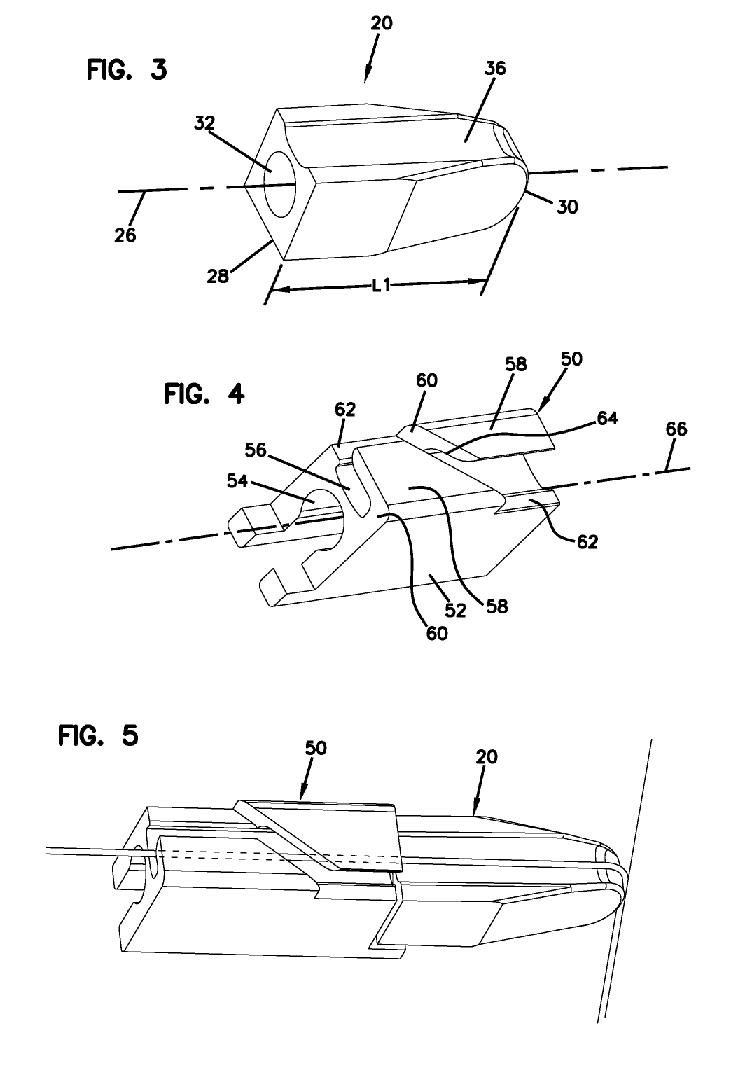

In certain examples, the tool includes a metal working tip 20 (see FIG. 3) that mounts on a heating element 22 (see FIG. 2) of a heat gun 24 (see FIG. 1) such as a soldering gun and that is configured to be rapidly heated to a desired working temperature suitable for softening the hot-melt adhesive of the line. In certain examples the working tip 20 is elongated along an axis 26 that extends along a length L1 of the working tip 20. The working tip 20 includes a proximal end 28 and a distal end 30 separated by the length L1. The proximal end 28 defines a receptacle 32 for receiving a tip 34 of the heating element 22. The distal end 30 is rounded for pressing the adhesive coated line onto a building structure. In certain examples, the working tip 20 defines an exterior groove 36 that extends along the length L1 of the working tip 20 from the proximal end 28 to the rounded distal end 30. The groove 36 also extends around the distal end 30. In certain examples, the length L1 of the working tip 20 is less than 50 percent of a length L2 of the heating element 22 or less than 40 percent of the length L2 of the heating element 22. In certain examples, the working tip 20 has a weight less than 2.5 grams, or less than 2 grams, or less than 1.5 grams or less than 1.25 grams, or in the range of 1 to 2 grams or in the range of 1 to 1.5 grams. In certain examples, the working tip 20 has a volume less than 0.07 cubic inches, or less than 0.06 cubic inches, or less than 0.05 cubic inches, or in the range of 0.02 to 0.06 cubic inches, or in the range of 0.03-0.05 cubic inches. The working tip 20 can include expansion slots 40 for allowing the receptacle 32 to elastically expand to receive the tip of the heating element 22.

In certain examples, the heat gun 24 is battery powered and has a battery life of at least 2 hours of use. In certain examples battery/batteries provide an output voltage to the heating element of 3 volts. In certain examples, the batteries include two pairs of 1.5 volt batteries arranged in parallel. In certain examples, the heating element has a nominal temperature less than 400 F, or less than 300 F or less than 250 F.

In certain examples, the tool also includes a guide sleeve 50 that mounts on the heating element 22 at a location axially adjacent to the proximal end of the working tip 20 (see FIG. 6). In certain examples, the guide sleeve 50 has a polymeric (e.g., plastic) construction. In certain examples, the guide sleeve 50 has a non-heat conductive (i.e., dielectric) construction. In certain examples, the guide sleeve 50 has a construction that is substantially less heat conductive than the construction of the working tip 20. In certain examples, the guide sleeve 50 includes a main body 52 defining a longitudinal passage 54 that receives the heating element 22 and that co-axially aligns with the receptacle 32 of the working tip 20. In certain examples, the guide sleeve 50 includes a longitudinal line guide channel 56 that co-axially aligns with the exterior groove 36 of the working tip 20. In certain examples, the guide sleeve 50 is configured such that that a line can be laterally loaded into line guide channel 56. In certain examples, the guide sleeve 50 includes line retention tabs 58 that are axially separated from one another and that overhang the line guide channel 56. In certain examples, the line retention tabs 58 have base ends 60 connected to channel rails 62 of the guide sleeve 50 on opposite sides of the line guide channel 56. In certain examples the line retention tabs 58 are separated by a slot 64 that extends at an oblique angle relative to a longitudinal axis 66 of the line guide channel 56.

1. A tool for attaching a line having pre-coated hot melt adhesive to a structure, the tool comprising:
a heating device including a heating element;
a working tip that mounts on a tip of the heating element;
a line guide sleeve that mounts on the heating element axially adjacent to the working tip.

2. The tool of claim 1, wherein the working tip is more heat conductive than the line guide sleeve.

3. The tool of claim 1, wherein the working tip is metal and the line guide sleeve is plastic.

4. The tool of claim 1, wherein the working tip has a length than is less than 50 percent as large as a length of the heating element.

5. The tool of claim 1, wherein the working tip has a weight less than 2.5 grams.

6. The tool of claim 1, wherein the working tip has a weight less than 2.0 grams.

7. The tool of claim 1, wherein the working tip has a weight less than 1.5 grams.

8. The tool of claim 1, wherein the working tip has a volume less than 0.07 cubic inches.

9. The tool of claim 1, wherein the working tip has a volume less than 0.06 cubic inches.

10. The tool of claim 1, wherein the working tip has a volume less than 0.05 cubic inches.

11. The tool of claim 1, wherein the line guide sleeve defies a line channel in which a line can be laterally inserted without removing the line guide sleeve from the heating element.

12. The tool of claim 11, wherein the line guide sleeve includes retention tabs that overhang the line guide channel, the ate axially spaced from one another, and that have base ends attached to opposite side rails of the line guide sleeve positioned at opposite sides of the line guide channel.

13. The tool of claim 12, wherein the retention tabs are axially separated by a oblique slot.

14. The tool of claim 1, wherein the working tip has a proximal end defined a receptacle for receiving the tip of the heating element, a distal end that is rounded, and an exterior channel that extends from the proximal end along a length of the working tip and around the distal end of the working tip.

15. The tool of claim 1, wherein the heating device is battery powered and provides a 3 volt output to the heating element.

16. The tool of claim 1, wherein the heating element of the heating device has a nominal heated temperature less than 400 F.
